(19) United States
(12) Patent Application Publication
(10) Pub. No.: US 2019/0092204 A1
(43) Pub. Date: Mar. 28, 2019

(54) METHOD FOR OPERATING AN ELECTROMOTIVE MASSAGE DEVICE OF A SEAT

(71) Applicant: Brose Fahrzeugteile GmbH & Co. Kommanditgesellschaft, Bamberg, Bamberg (DE)

(72) Inventors: Christian MERGL, Zeil (DE); Thomas WEINGAERTNER, Memmelsdorf (DE); Peter HORN, Kemmern (DE); Alexander MUELLER, Bischberg (DE); Stefan BICKEL, Bamberg (DE); Matthias MARKERT, Hassfurt (DE); Uwe SOMMER, Effelder (DE); Sebastian DORSCH, Kemmern (DE)

(73) Assignee: Brose Fahrzeugteile GmbH & Co. Kommanditgesellschaft, Bamberg., Bamberg (DE)

(21) Appl. No.: 16/146,296

(22) Filed: Sep. 28, 2018

(30) Foreign Application Priority Data
Sep. 28, 2017 (DE) 10 2017 217 331.9

(51) Int. Cl. B60N 2/90; B60N 2/00; A61H 23/02

(52) U.S. Cl. CPC B60N 2/976; B60N 2/002; A61H 2203/0431; A61H 2201/5061; A61H 2201/5064; A61H 23/02

(57) ABSTRACT

A method for operating an electromotive massage device of a seat, in particular of a motor vehicle, comprising a massage drive having an electric motor. The electric motor is energized, and a torque of the electric motor is detected, and a first reference value is calculated therefrom. Based on the first reference value, the occupancy of at least one section of the seat is determined. An electromotive massage device of a seat and a seat of a motor vehicle are also provided.

This nonprovisional application claims priority under 35 U.S.C. § 119(a) to German Patent Application No. 10 2017 217 331.9, which was filed in Germany on Sep. 28, 2017, and which is herein incorporated by reference.

### BACKGROUND OF THE INVENTION

### Field of the Invention

The present invention relates both to a method for operating an electromotive massage device of a seat, which comprises a massage drive with an electric motor, as well as an electromotive massage device of a seat. The seat is in each case preferably a component of a motor vehicle. Furthermore, the invention relates to a seat of a motor vehicle.

### Description of the Background Art

Motor vehicles comprise a number of auxiliary units which do not directly serve the propulsion of the motor vehicle. In most cases, these auxiliary units boost the comfort for the user of the motor vehicle. An electromotive massage device that is part of a motor vehicle seat is such an auxiliary unit. Upon activation, a certain area of the vehicle seat is hereby adjusted intermittently, such as a backrest or part of a backrest. Due to this, the blood circulation of a user of the vehicle seat is stimulated, making the vehicle more pleasant to use. Also, in this way, comparatively long journeys can be undertaken in the motor vehicle without the user becoming tired.

Motor vehicle seats also usually have a seat occupancy recognition. As a function of the seat occupancy recognition, for example, the correct application of the seat belt is monitored and, optionally, a warning signal is emitted. In addition, in a crash and in order to save costs, the airbags are usually only activated if the seat is occupied. To recognize whether a seat is occupied, a weight sensor is generally used, or the deformation of the seat is detected due to being occupied by a person. Alternatively, a capacitive sensor electrode is used by means of which an electromagnetic field is created and monitored in the area of the seat. When operating, the change in dielectric constant due to the change in the capacitance is detected. The change in dielectric constant is due to the presence of a person in the area of the seat. If a change in capacity is detected, seat occupancy is also detected.

### SUMMARY OF THE INVENTION

It is therefore an object of the present invention to provide a particularly suitable method for operating an electromotive massage device of a seat and a particularly suitable electromotive massage device of a seat as well as a particularly suitable motor vehicle seat, wherein in particular manufacturing costs are reduced and preferably service life and/or comfort are increased and suitably, acoustic impression is improved.

The method is used to operate an electromotive massage device. The electromotive massage device is part of a seat, and characteristically, a massage function is performed by the electromotive massage device. Here, for example, a part of the seat, such as the seat surface or a backrest, is moved, in particular intermittently. The seat and thus the electromotive massage device are preferably a component of a motor vehicle, and the seat is, for example, a driver's seat or a passenger seat.

The electromotive massage device has a massage drive with an electric motor. By means of the electric motor, in particular, a further component of the massage drive is driven, by means of which a massage function is performed. For example, by means of the further component, for example a vibration element, an imbalance or a piston, a part of the seat is bulged, in particular intermittently. The further component is suitable, expediently provided and configured for this purpose. For example, the electric motor may be a brush commutator motor. However, particularly preferred, the electric motor is brushless and in particular a brushless DC motor (BLDC). For example, the electric motor may be an asynchronous motor, but can be a synchronous motor. The electric motor is three phase in particular, wherein the individual phases are connected together, for example, in a delta or star connection.

The method provides that the electric motor is energized in one step. For this purpose, for example, a certain electrical voltage is applied to the electric motor. In particular, the electrical voltage is predefined. Alternatively, for example, the electric current flow may be adapted to the electric motor. In particular, the electrical voltage/electric current is provided by means of an inverter, which, for example, has a bridge circuit, such as a B6 circuit.

In a further step, the torque of the electric motor is detected. In other words, the torque of the electric motor is determined, the former resulting due to the energization. Based on the torque, a first reference value is calculated. The first reference value, for example, has only two values as a possible value set. In particular, one value is used in this case for the first reference value when the torque is above a certain threshold; otherwise, the other value is used. Alternatively, the value range of the first reference value is increased and/or in particular discrete. Alternatively, the value range of the first reference value is continuous. At a minimum, there is a functional relationship between the first reference value and the torque, wherein for example, a one-to-one assignment is made. For example, the detected torque is used as the first reference value.

In a further step, the occupancy of at least a section of the seat is determined by means of the first reference value. In particular, the section corresponds completely or at least partially to the part of the seat which is moved when the electric motor is energized. In other words, the first reference value indicates a portion is occupied. In particular, occupancy is the weight on the portion due to the presence of a person. In other words, it is determined whether the person on the section is sitting on it or is leaned against it, i.e., whether the person, especially a driver of the vehicle, is in mechanical contact with the section. Thus, based on the torque of the electric motor or based on the first reference value derived therefrom, occupancy of the section of the seat is determined. If a relatively high torque is required to move the section and consequently prevails, it is likely that the section is occupied. If the section is not occupied, only a comparatively low torque is required. Consequently, it is therefore possible to determine the occupancy of the section by means of the torque and therefore also by means of the first reference value. As a result, no further sensors or the like are required, which is why production costs are reduced. For example, occupancy may be determined binarily, that is, it is determined whether or not there is an occupancy. Alternatively, occupancy is determined qualitatively, i.e., in particular, with how much pressure/weight the section is loaded.

Conveniently, the electromotive massage device has several such massage drives, which are assigned to different sections of the seat. Thus, it is possible to determine the position of the user on the seat by means of the massage drives. In particular, the sitting position of the user on the seat is determined based on the occupancy. As a function of the determined (sitting) position of the user, for example, a potential adjusting movement of the seat is limited, in particular an electromotive adjustment of the seat, e.g., an electromotive adjustment of the backrest of the seat, that is, its angle of inclination relative to the seat surface or to a transverse movement of the seat. Alternatively or in combination therewith, a further adjustment of the motor vehicle is made on the basis of the determined seat position, provided that the electromotive massage device is part of the motor vehicle. For example, the setting of an air conditioning system, an audio system or a seat belt/belt drive may be affected. Consequently, comfort is further increased.

The torque of the electric motor is determined, for example, by means of the power consumption. In other words, the first reference value is calculated from the power consumption. For example, the electric current flow to the electric motor is detected and the torque is derived therefrom. For example, a motor model may be used for this purpose. Alternatively, the electric current is used directly as a torque, which simplifies the calculation. Due to the determination of the power consumption, merely a relatively cost-effective sensor is required, which is present, for example, in particular when the electric motor is controlled. As a result, manufacturing costs are reduced.

The first reference value can be compared with a second reference value for determining the occupancy. In the comparison, it is verified, for example, whether the first reference value is greater than the second reference value or vice versa. If the first reference value is greater or less than the second reference value, then in particular occupancy is detected. The second reference value is predetermined, for example, based on a theoretical model and/or is predefined and/or determined based on the electric motor used. However, particularly preferred, the second reference value is calculated from a torque of the electric motor, which results when the section is not occupied. In other words, it is first ensured that the section is not occupied and then, the electric motor is energized. The resulting torque of the electric motor is detected and the second reference value is calculated therefrom. For example, the second reference value is calculated in the same manner as the first reference value. In other words, the same calculation rule is used to determine the second reference value as the one used for determining the first reference value. For example, the torque may be used as a second reference value. Preferably, a tolerance value or the like is additionally used, such that the second reference value is calculated in the same manner as the first reference value and the tolerance value is added to this finding. This finding is used as the second reference value.

The second reference value can be calculated when the motor vehicle is closed and, for example, locked from the outside, thus ensuring that the section is not occupied. Alternatively, for example, the second reference value is calculated directly after unlocking the motor vehicle from the outside. In a further alternative, the second reference value is calculated for example after production of the electromotive massage device and, for example, after production of the motor vehicle, in particular on a test stand. The second reference value is stored, for example, in a memory of the electromotive massage device. As an alternative thereto, the second reference value is recalculated, for example, cyclically. In this way, for example, wear and tear or the like is taken into account.

For example, the first reference value is calculated based on a change in the torque of the electric motor. In other words, the change of the torque is first determined, and, based on that, the first reference value is calculated. In particular, it is determined in this way at what point in time the torque of the electric motor changes. Here, in particular, the torque curve or a value corresponding thereto is determined. When the torque changes, for example, the first reference value is calculated. The latter suitably corresponds to a specific angular position of the electric motor. In particular, provided that a piston or the like are driven by the electric motor, the torque changes when the piston is moved against a cover of the seat and bulges it, for example, to the outside. Therefore, an increase in torque occurs due to the mechanical resistance which is present at a minimum because of the cover and, for example, due to the occupancy. In other words, in this case, the piston is moved against the user. This location is used, for example, as a first reference value or at least the angular position of the electric motor. Thus, it is determined from which angular position of the electric motor the torque must be applied in order to move the seat cover or at least a surface of the seat. If the section is occupied, this location is offset in the direction of the electric motor, as long as the seat is designed at least partially resilient. Consequently, the position of the surface of the section and, thus, whether or not it is occupied, can be inferred from the angular position of the electric motor in which the increase in torque occurs.

The energization of the electric motor can be adjusted according to the first reference value. The energization of the electric motor can be adjusted if the section is determined to be not occupied. In particular, the energization of the electric motor is stopped, which reduces the power demand. Also, the electric motor is prevented from heating up in this way, so that its service life is increased. Alternatively, at least, the electric motor is operated at a rotational speed at which the emission of acoustic waves is reduced. Thus, comfort is enhanced and acoustic impression is improved. Suitably, the energization of the electric motor is amplified when there is an occupancy, but relatively little. If there is an occupancy and it is relatively heavy, for example, then energization is reduced to lessen overloading of the electric motor. In particular, a movement pattern of the electric motor is adjusted, especially if the occupancy is determined/detected. Thus, comfort is further increased.

For example, the reference value is calculated by means of a calibration run. For this purpose, for example, after activation of the electromotive massage drive, the first reference value is calculated, and thus the occupancy. The first reference value and the occupancy determined in this way cannot be determined again, for example, while the electromotive massage device is operating and are therefore constant throughout the entire operation. For example, the first reference value, and thus the occupancy, are determined when user input is present. Suitably, the user input corresponds to the activation of the electromotive massage device. Particularly preferably, the first reference value is determined again cyclically, for example every 5 seconds, every 10 seconds, every minute, every 5 minutes or every 10 minutes. Thus, the occupancy of the section is also cyclically recalculated, and thus it is in particular possible to influence the energization of the electric motor and/or further functions of a possible motor vehicle in accordance with the current occupancy.

The electromotive massage device is a component of a seat and, for example, a component of a motor vehicle. For example, the electromotive massage device can be part of a driver's seat or a passenger seat. The electromotive massage device has a massage drive with an electric motor and a control device. The electromotive massage device serves to provide a massage function. Suitably, the massage drive is provided and configured to adjust a section of the seat, for example, a backrest, a seat surface, or at least a portion thereof, in particular intermittently. For example, the section may be bulged out.

The electromotive massage device is operated in accordance with a method in which the electric motor is energized, and in which a torque of the electric motor is detected and from this, a first reference value is calculated. Based on the first reference value, an occupancy of at least a section of the seat is determined. For example, the electromotive massage device is used in order to perform the method. Suitably, during operation of the electric motor, the section or at least a portion of the section is expediently moved by means of the electric motor. Specifically, the control device is suitable, preferably provided and configured, to perform the method. For example, the control device is a central control device (control unit) of the electromotive massage device or a component of the massage drive, and suitably attached to the electric motor. For example, the control device additionally serves to adjust the energization of the electric motor. Preferably, the electromotive massage device additionally comprises a central control unit by means of which, for example, communication takes place with additional components, such as an input device and/or a bus system, in particular if the massage device is part of the motor vehicle.

The massage drive has, for example, an imbalance that is driven by the electric motor. Due to this imbalance, the massage drive is suitably set in motion, wherein movement is intermittent. In this case, the massage drive is expediently coupled with a further component of the seat in the assembled state, for example, a backrest or seat surface, so that the respective component is moved by means of the imbalance, in particular bulged out.

Conveniently, the massage drive has a spring-loaded piston that is movable in a specified direction. Here, the piston is loaded in the specified direction in particular by means of the spring. The specified direction is suitably directed towards the section. Suitably, the specified direction is directed towards a cover of the seat and is in particular perpendicular thereto. The spring is, for example, a coil spring or a pneumatic spring element. Preferably, the spring is a compression spring. The position of the piston in the specified direction is limited by means of a cable. For example, the cable is attached to the piston. At a minimum, the movement of the piston is limited in the specified direction by the cable. Further limitation of the position of the piston in the given movement is also possible, for example, according to whether or not the section is occupied. At a minimum, a theoretical maximum position of the piston in the specified direction is preferably limited by the cable.

The cable counteracts the direction of force of the spring. Thus, the piston is offset against the spring force by means of the cable and is held in this position by the cable. The cable, for example, is made of plastic. In particular, the cable is slack. Alternatively, the cable is rigid and made for example in the manner of a toothed rack. The cable is in operative connection with the electric motor. For example, the cable is at least partially rolled up on a cable pulley, which is driven by the electric motor. Thus, upon energization of the electric motor, the position of the piston is set in the specified direction by means of the cable.

For example, the first reference value corresponds to the extension of the spring. The extension of the spring corresponds in particular to the extension of the cable. For example, the first reference value corresponds to the extension of the spring when the cable transitions from a slack to a taut state. This change of state of the cable is determined in particular from an increase in torque. If the piston abuts, for example, on the section, its position is thus determined by means of the section. In this case, the cable is not taut, for example, between the piston and a possible cable pulley.

To determine occupancy, the cable is suitably initially completely released and the position of the piston is thus determined by means of the section. In other words, the piston suitably abuts the section and the cable is slack. The electric motor is subsequently driven and the cable is at least partially rolled up on the pulley. When the cable is taut, it is necessary to apply further torque on the pulley by means of the electric motor, and thus a greater force, which counteracts the spring force, in order to space the piston from the section. The extension of the spring or of the cable during this increase in torque is expediently used as the first reference value. Specifically, the first value is thus compared with the second reference value, which is calculated in particular when the section is not occupied. If the extension of the spring is less than the extension of the spring in the unoccupied state, that is to say, in particular if the first reference value is smaller than the second reference value, occupancy is expressly determined.

The seat can be a component of a motor vehicle and has an electromotive massage device. The seat is thus a vehicle seat and expediently, a driver's seat, i.e., the seat, which is occupied by the conductor of the motor vehicle. The (vehicle) seat comprises, in particular, a seat surface and suitably a backrest. The seat surface and/or the backrest conveniently have a molded part made of cold foam, which has a covering made of, for example, fabric or leather. The electromotive massage device has a massage drive with an electric motor. The massage drive is expediently arranged in a recess within the molded part made of cold foam, and during operation, the cover, i.e., in particular the fabric or the leather, is suitably bulged, in particular intermittently. The electromotive massage device further comprises a control device and is operated according to a method in which the electric motor is energized, and in which a torque of the motor is detected and from this, a first reference value is calculated. Occupancy of at least a section of the seat is determined using the first reference value.

The developments and advantages explained in connection with the method for operating the electromotive massage device are analogously also applicable to the electromotive massage device/use and/or to the seat and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a motor vehicle with a seat comprising an electromotive massage device in a schematically simplified form,

FIG. 2 is a perspective view of the seat with the electromotive massage device,

FIG. 3 is a perspective view of the electromotive massage device with a plurality of massage drives,

FIG. 4 is a schematic view of one of the massage drives,

FIG. 5 is a schematic view of another embodiment of the massage drive, and

FIG. 6 illustrates a method for operating the electromotive massage device.

### DETAILED DESCRIPTION

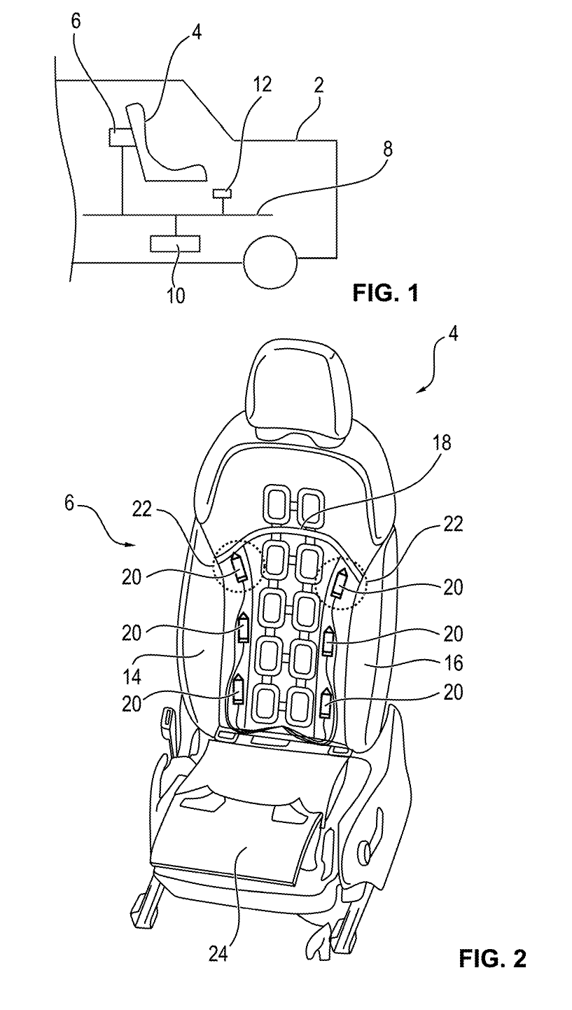

FIG. 1 shows a motor vehicle 2 with a (vehicle) seat 4 in a schematically simplified form. The vehicle seat 4 comprises an electromotive massage device 6, which is connected by a signal with a bus system 8. The bus system 8 is based on the CAN standard, and an onboard computer 10 as well as a further bus device 12 are each a component of the bus system 8. By means of the onboard computer 10, requests are transmitted to the electromotive massage device 6 and to the other bus devices 12. Also, an exchange of operating data takes place via the bus system 8.

FIG. 2 shows the seat 4 configured as a driver's seat in a perspective view, but without a seat cover. The (driver's) seat 4 comprises a backrest 14, which includes a molded part 16 made of cold foam, in which a metal support structure 18 is embedded that acts as a stabilizer. The molded part 16 has a number of recesses, wherein within each, a respective massage drive 20 of the electromotive massage device 6 is disposed. The massage drives 20 are spaced from each other, and each of the massage drives 20 is assigned a section 22. The sections 22 correspond to the sections of the seat 4 which are bulged or at least moved during operation of the respectively assigned massage drive 20. The seat 4 also has a seat surface 24 to which massage drives are assigned.

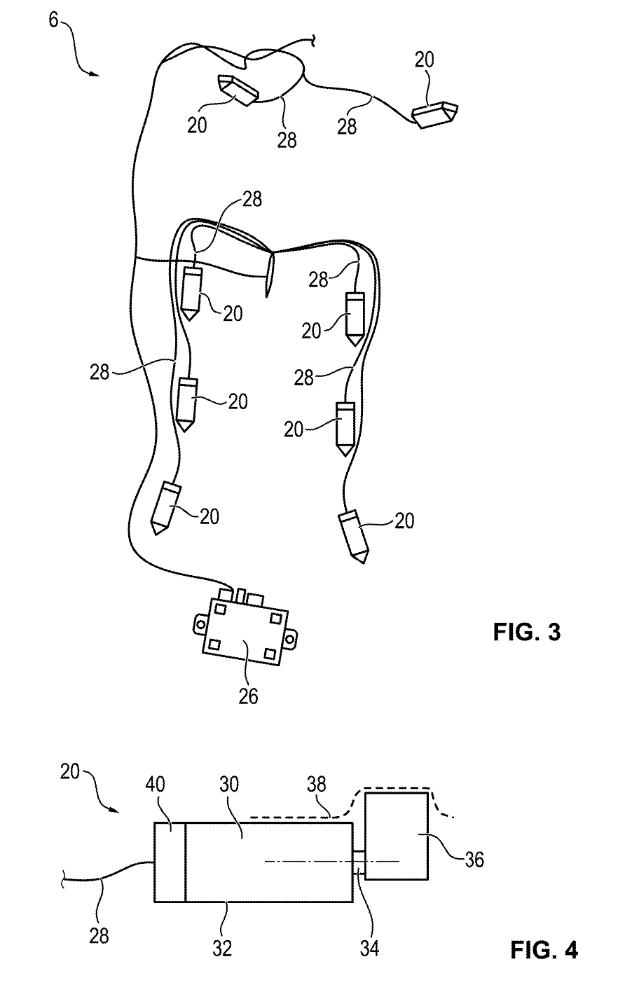

FIG. 3 shows the electromotive massage device 6, which comprises a control unit 26 and the overall eight massage drives 20. The massage drives 20 are each coupled electrically and signal-technically to the control unit 26 by means of electrical lines 28.

FIG. 4 illustrates a first embodiment of the massage drive 20, wherein all massage drives 20 are, for example, identical to each other. The massage drive 20 has an electric motor 30 with a housing 32 made of a metal sheet. An imbalance 36 is connected to a shaft 34 of the electric motor 30, which is thus driven by means of the electric motor 32. During a rotational movement of the electric motor 32 and thus a rotational movement of the imbalance 36, the massage drive 20 is set in rhythmic motion so that the associated section 22 vibrates. Alternatively or in combination therewith, a seat cover 38 of the seat 4 is intermittently bulged by means of the imbalance 36. The massage drive 20 comprises a control device 40, by means of which current is supplied to the electric motor 32. The control device 40 is in electric contact with the electrical line 28, and during operation, data is exchanged between the control unit 26 and the control device 40 by means of the electrical line 28, wherein by means of another wire of the electrical line 28, an electric current flow is provided to the control device 40.

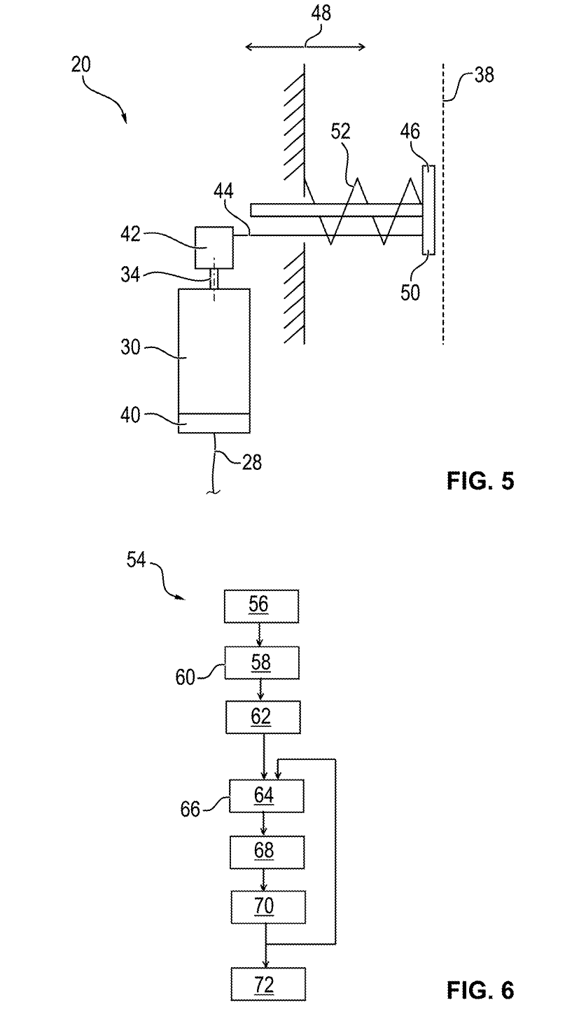

FIG. 5 shows a further embodiment of the massage drive 20 in a schematically simplified form. The electric motor 30, a brushless DC motor (BLDC), the control device 40 and their connection to the electrical line 28 are not modified. A cable pulley 42 is rotatably connected to the shaft 34, on which a cable 44 is at least partially rolled up. The cable 44 is further attached to a piston 46 which is movable in a given direction 48 by means of a non-illustrated guide. Perpendicular to the given direction 48, a piston plate 50 of the piston 46 is arranged, which is disposed substantially parallel to the seat cover 38. The piston 46 is loaded by means of a compression spring 52 in the form of a coil spring, so that by means of the spring 52, the piston plate 50 is pressed in the specified direction 48 by the electric motor 30 against the seat cover 38. For this purpose, the spring 52 is supported on a stationary component of the seat 4.

The position of the piston 46 is limited by the cable 44, and by means of the electric motor 30, the piston 46 can be moved in the specified direction 48, counter to the force applied by the spring 42. By unwinding the cable 44 from the pulley 42, the piston 46, and in particular the piston plate 50, is moved against the seat cover 38 by the spring 52. With a relatively fast unwinding of the cable 44, the seat cover 38 is thus bulged.

FIG. 6 shows a method 54 for operating the electromotive massage device 6 of the seat 4. The method 54 is carried out either by means of each of the control devices 40 of the massage drives 20 or by means of the control unit 26. If the control unit 26 is used, the method 54 is performed separately for each of the massage drives 20, for example, successively in time or simultaneously. In a first step 56, which is carried out when the motor vehicle 2 is unlocked from the outside, the electric motor 30 of each of the massage drives 20 is energized, thereby moving the imbalance 36 or the piston 46. For this purpose, an electrical voltage is applied to the electric motor 30 by means of the control device 40. Thus, in the first step 56, the seat 4 is not occupied and consequently, neither are any of the sections 22.

In a subsequent second step 58, the torque of the electric motor 30 is determined. For this purpose, the power consumption of the electric motor 30 is determined, i.e., the electrical current flow resulting from the application of the electrical voltage. If the massage drive 20 is designed according to FIG. 4, an average power consumption results which is averaged over several revolutions of the imbalance 36. The average value of the electric power consumption is hereby used as a second reference value 60.

If the massage drive 20 is formed in accordance with FIG. 5, the cable 44 is fully released by the pulley 42. As a result thereof, the piston plate 50 moves in the specified direction 48 on account of the spring 52 until it rests on the seat cover 38 and is retained by the seat cover 38. Subsequently, the cable pulley 42 is moved in the reverse direction and the cable 44 is rolled up. As long as the latter sags, the torque applied by means of the electric motor 30 is comparatively small. Once the cable 44 is tightened and moves the piston 46 against the force of the spring 52 in the specified direction 48, the torque increases. In other words, the torque changes. The position of the electric motor 30 present at this time is used as the second reference value 60. Thus, the second reference value 60 corresponds to the extension of the spring 52, provided that the section 22 that is associated with the respective massage drive is not occupied.

In a third step 62, a request is received via the bus system 8 to start the massage function of the electromotive massage device 6. This request is generated, for example, by means of the onboard computer 10, which detects a corresponding user input. In this case, the driver of the motor vehicle sits on the seat 4, so that at least portions of the sections 22 are occupied. In a subsequent fourth step 64, the electric motor 30 is energized. Further, the resultant torque of the electric motor 30 is detected in that the electrical power consumption is determined by the latter. If the massage drive is configured 20 according to the variant shown in FIG. 4, the average electrical power consumption for a determined time window is calculated, wherein in this case, for example, several revolutions of the imbalance 36 are present. The resulting average electrical power consumption is used as a first reference value 66.

If the massage drive 20 is designed according to the variant shown in FIG. 5, in turn, the cable 44 is completely released, and the piston plate 50 is pressed against the seat cover 38 by means of the spring 52. Subsequently, in turn, the cable 44 is rolled up by means of the pulley 42. If the cable 44 is taut, a further winding takes place on the pulley 42 against the force of the spring 52, so that the torque applied by means of the electric motor 30 increases, and also its electrical power consumption. The present angular position of the electric motor 30, i.e., in particular the number of revolutions completed after the complete release of the cable 44, is used as the first reference value 66. Thus, the first reference value 66 is calculated based on a change in torque 30, and the first reference value 33 corresponds to the length of the cable 44, which is not rolled up on the pulley 42, and thus to the extension of the spring 52.

In a subsequent fifth step 68, the first reference value 66 is compared to the second reference value 60. In this case, if the massage drive 20 is configured in accordance with FIG. 4, it is verified whether the first reference value 66 is greater than the second reference value 60, i.e., whether the power consumption of the electric motor 30 is increased. If the section 22 is occupied, i.e., the user rests against the section 22, it is necessary that the imbalance 36 be moved not only against the seat cover but also against the body of the driver, so that the torque required for the rotation of the imbalance 36 is increased. Consequently, occupancy is inferred if the torque and thus the first reference value 66 are increased and are greater than the second reference value 60. Inferring that occupancy is present is made in particular qualitatively, i.e., whether the section 22 is occupied or not. Alternatively, a qualitative assessment can take place, i.e., to which degree the driver is leaning on the backrest 14. If the massage drive 20 is constructed in accordance with FIG. 5, occupancy is inferred if the first reference value 66 is greater than the second reference value 60, that is, if the pulley 42 is rotated by a greater amount, which corresponds to a reduced extension of the spring 52 in the specified direction 48.

In a subsequent sixth step 70, the energization of the electric motor 30 is adjusted based on the first reference value 66 and the detected occupancy. In this case, the energization of the electric motor 30 is terminated provided that the associated section 22 is not occupied. Alternatively, a current is applied such that a rotational speed of the electric motor 30 results in which the emission of acoustic waves is reduced. If the massage drive 20 shown in FIG. 5 is used, the cable 40 is released during operation only up to the first reference value 66. As a result, the piston 46 is moved against the seat cover 38. Following this, the cable 44 is rolled up again and the piston 46 is spaced from the seat cover 38. Then, in turn, the cable 44 is released up to the first reference value 66. Thus, the seat cover 38 is intermittently moved outward, thereby reducing the load on the electric motor 30 due to idling. Also, the time interval is reduced between the application of the piston plate 50 to the seat cover 38 and the renewed spacing to the latter.

For example, symmetrically arranged massage drives 20 are always identically energized, which increases comfort. The determined occupancy is transmitted to the control unit 26 by means of the electric lines 28, and the pattern by which the massage drives 20 are operated are adapted on the basis of each occupancy that is detected. Also, a travel path of the seat surface 24 and the backrest 40 is changed by means of a electromotive drive so that for example unintentional movement, in particular to a position in which safe sitting is no longer possible, is prevented. Also, the occupancy of the seat 4 determined in this way is compared with other sensors that are used, for example, to trigger an airbag. If a discrepancy exists, in particular, an error message is issued.

The first reference value 66 is recalculated cyclically, for which purpose the fourth, fifth and sixth steps, 64, 68, 70 are executed every minute. The electric motors 30 are energized until, in a seventh step 72, a request to end the massage function is received by the control unit 26 via the bus system 8. This is communicated to all control devices 40 and the operation of the respective electric motors 30 is ended.

In summary, the massage drives 20 are installed within the molded parts 16, which are created in particular from a seating foam. The electrical power consumption of the electric motors 30 of the massage drives 20 varies as a function of the load on the seat surface 24/the backrest 14, i.e., as a function of the occupancy of the associated section 22. Thus, in particular, the electrical power consumption of each of the electric motors 30 depends on the load on the respective seat structure. By evaluating the electric power consumption, in particular the occupancy is recognized, i.e., occupancy of a seat is detected. Provided one of the sections 22 is not occupied, the massage drive 20 associated with this section 22 is energized less or is entirely switched off. The method 54 is performed, for example, by means of the control devices 40 or the control unit 26, which functions as a control device.

In other words, the intensity distribution, by means of which sections of the seat 4 are moved by the massage drives 20, is adapted by the change in energization of the electric motors 30 as a function of the detected occupancy. By means of a pre-characterization of the individual massage drives 20 in idle mode, i.e., by means of determining the second reference value 60, it is possible by comparing with the first reference value 66 to determine based on the electrical power consumption of the respective massage drive 20 whether a person is sitting on the seat 4. Furthermore, it is possible to recognize which of the massage drives 20 is currently loaded and thus being used.

The unused massage drives 20 are switched off, for example, or operated at an acoustically advantageous operating point, that is to say in particular at a lower intensity. For example, symmetrically arranged massage drives 20 are identically energized, which further increases comfort. By switching off the individual electric motors 30, energy demand is reduced and system temperature is influenced positively. It is also possible to obtain comparatively detailed seat occupancy recognition, in particular with regard to a modular vehicle interior. It is also possible to check the plausibility of possible existing seat occupancy recognition. Alternatively, there may be no need for additional seat occupancy recognition, which saves costs.

When using the massage drive 20 shown in FIG. 5, the load of the individual massage drives 20 is determined and the massage is adjusted to the occupant based on this information. Once a person has taken place on the seat 4, a calibration run is performed and the first reference value 66 is calculated. In this case, the cables 44 are released until the spring 52 is capable of reaching its theoretical end position, i.e., the position that occurs if the respective section 22 is not loaded and the piston 46 is retained by means of the seat cover 38. The theoretical end position suitably corresponds to the second reference value 60. Due to the load caused by the user when occupying the section 22, the extension of the springs 52 is limited and the piston 46 comes to rest at a different position. As a result, the cable 44 is slack. Subsequently, the cable 44 is rolled up by means of the pulley 42. As long as the cable 44 is slack, i.e., not yet operating against the spring force, the electric current required for driving the electric motor 30 is comparatively low. Once the cable 44 no longer sags and the spring 52 is compressed, the electrical power consumption increases and consequently, also the torque. This position at which this occurs is stored by the electromotive massage device 6 and is used in particular as a first reference value 66. The pressure distribution on the seat 4 is obtained via the spring rate. As a result, it is possible to adapt the travel paths of the individual pistons 46 or an entire massage pattern.

It is also possible to use the measured information about the occupancy, i.e., about the pressure distribution, in order to adapt the massage function, i.e., in particular, to obtain a certain pattern by means of the electric motors 30 or to switch off individual electric motors 30. Alternatively or in combination herewith, the measured information regarding the occupancy (pressure distribution) on the seat surface 24 and/or on the backrest 14 is used to tailor different adjustment options of the seat 4, for example, the adjustment speed of the backrest 14 or the seat surface 24. Alternatively or in combination herewith, further settings of the motor vehicle 2 are adapted to the user on the basis of the information.

By means of the electromotive massage device 6, it is further possible to gain information about the user such as, for example, their body height, proportions, posture, seat position and/or weight. For example, this information may be stored. Furthermore, it is possible to adapt the massage function to the user, resulting in increased comfort. It is also possible to adjust possible electrical seat adjustments to the user, which in turn increases comfort. Other settings of the motor vehicle 2 can also be adjusted on the basis of the obtained data, which again leads to an increase in comfort. For example, the calculation of the first and/or second reference value 60, 66 is performed in a calibration run, which takes place, for example, automatically or in response to user input.

The invention is not limited to the embodiments described above. Rather, other variants of the invention can be derived therefrom by the person skilled in the art without departing from the subject matter of the invention. In particular, furthermore, all individual features described in connection with the individual exemplary embodiments can also be combined with one another in other ways, without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A method for operating an electromotive massage device of a seat a motor vehicle, the method comprising:
providing a massage drive with an electric motor;
energizing the electric motor;
detecting a torque of the electric motor;
calculating a first reference value based on the detected torque; and
calculating, based on the first reference value, an occupancy of at least a section of the seat.

2. The method according to claim 1, wherein the torque of the electric motor is determined based on a power consumption.

3. The method according to claim 1, wherein the first reference value is compared with a second reference value to determine the occupancy, and wherein the second reference value is calculated from a torque of the electric motor which is obtained if the section is not occupied.

4. The method according to claim 1, wherein the first reference value is calculated based on a change in the torque of the electric motor.

5. The method according to claim 1, wherein the energization of the electric motor is adjusted according to the first reference value.

6. The method according to claim 1, wherein the first reference value is cyclically recalculated.

7. An electromotive massage device of a seat of a motor vehicle, the device comprising:
a massage drive with an electric motor; and
a control device that is operated according to the method according to claim 1.

8. The electromotive massage device according to claim 7, wherein the massage drive comprises a spring-loaded piston that is movable in a specified direction, and wherein the position of the piston is limited in the specified direction by a cable that is in operative connection with the electric motor.

9. The electromotive massage device according to claim 8, wherein the first reference value corresponds to an extension of the spring.

10. A seat of a motor vehicle comprising the electromotive massage device according to claim 7.
